(19) United States
(12) Patent Application Publication
(10) Pub. No.: US 2026/0044667 A1
(43) Pub. Date: Feb. 12, 2026

(54) GENERATING AND SELF-CORRECTING WORKFLOWS FOR EDITING DIGITAL FILES USING LANGUAGE MACHINE LEARNING MODELS

(71) Applicant: Adobe Inc., San Jose, CA (US)

(72) Inventors: Puneet Mathur, College Park, MD (US); Varun Manjunatha, San Diego, CA (US); Tong Sun, San Jose, CA (US); Alexa Siu, San Mateo, CA (US)

(21) Appl. No.: 18/795,882

(22) Filed: Aug. 6, 2024

(51) Int. Cl. G06F 40/166; G06F 11/07; G06F 40/103

(52) U.S. Cl. CPC G06F 40/166; G06F 11/0766; G06F 40/103

(57) ABSTRACT

The present disclosure relates to systems, methods, and non-transitory computer-readable media that modify digital files in accordance with user requests. For instance, in some cases, the disclosed systems receive, from a client device, a user request for modifying a digital file. The disclosed systems generate, using a language machine learning model, a task plan having formatted code indicating one or more application programming interface calls to execute to modify the digital file. Further, the disclosed systems generate, via one or more code verifications on the formatted code, an error log that identifies one or more errors in the task plan. The disclosed systems generate, from the error log and using the language machine learning model, a corrected task plan that corrects the one or more errors. Additionally, the disclosed systems provide, for display, a modified digital file generated through execution of the corrected task plan.

### BACKGROUND

Recent years have seen significant advancement in hardware and software platforms for editing digital files, such as digital images or text documents. Indeed, as the use of digital files has become increasingly ubiquitous, systems have developed to facilitate the manipulation of the content within such digital files. To illustrate, many systems offer various tools that enable various changes to the content of digital files. Some systems use a model implementing artificial intelligence to generate a modified version of a digital file having edited content. Despite these advancements, conventional file editing systems often fail to implement editing workflows that accurately reflect editing intent, leading to inaccurate editing results that require significant user interactions and computer resources to correct.

### SUMMARY

One or more embodiments described herein provide benefits and/or solve one or more of the foregoing or other problems in the art with systems, methods, and non-transitory computer-readable media that use language machine learning models to generate, revise, and execute workflows for editing digital files. To illustrate, in one or more embodiments, the disclosed systems receive a user request along with a digital file to be modified and uses a language machine learning model (e.g., a large language model) to infer an editing intent and transform the inferred intent into a task plan consisting of editing tools to be applied in modifying the digital file. In some cases, the disclosed systems further use the language machine learning model to self-correct any errors in the task plan. The disclosed systems, in some embodiments, also generate a software program that orchestrates application programming interface (API) calls for the editing tools in accordance with the corrected task plan and revises the program to remove errors contained therein. Using the revised program, the disclosed systems modify the digital file in accordance with the user request. In this manner, the disclosed systems flexibly self-correct errors to implement an editing workflow that accurately reflects the editing intent of the user, leading to improved editing results with reduced user interactions, time, and corresponding resources.

Additional features and advantages of one or more embodiments of the present disclosure are outlined in the following description.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a text-to-file editing system operates in accordance with one or more embodiments;

FIG. 2 illustrates the text-to-file editing system editing a digital file in response to a user request in accordance with one or more embodiments;

FIG. 3 illustrates the text-to-file editing system employing various processes or steps in modifying a digital file in accordance with one or more embodiments;

FIG. 4 illustrates the operation and interaction of the processes used by the text-to-file editing system to modify a digital file in accordance with one or more embodiments;

FIGS. 5A-5D illustrate more detail regarding the processes discussed with reference to FIG. 4 in accordance with one or more embodiments;

FIG. 6 illustrates a dependency graph used by the text-to-file editing system for dependency consistency verification in accordance with one or more embodiments;

FIG. 7 illustrates example tool documentation used by the text-to-file editing system in accordance with one or more embodiments;

FIG. 8 illustrates a graphical user interface used by the text-to-file editing system to modify a digital file in accordance with one or more embodiments;

FIG. 9 illustrates an example schematic diagram of a text-to-file editing system in accordance with one or more embodiments;

FIG. 10 illustrates a flowchart of a series of acts for modifying a digital file based on a user request in accordance with one or more embodiments; and

FIG. 11 illustrates a block diagram of an exemplary computing device in accordance with one or more embodiments.

### DETAILED DESCRIPTION

One or more embodiments described herein include a text-to-file editing system that edits digital files by implementing editing workflows generated and revised using one or more language machine learning models. For instance, in certain cases, the text-to-file editing system orchestrates implementation of various editing tools via prompts to one or more language machine learning models in a series of steps including task plan generation, task plan verification and self-correction, multi-turn user feedback, and task plan execution via code generation and code self-revision. Indeed, in some cases, the text-to-file editing system uses one or more language machine learning models to generate a task plan for modifying a digital file and to further generate executable code from the task plan. In some embodiments, the text-to-file editing system further uses the language machine learning model(s) to revise the task plan and/or the executable code by correcting errors contained therein. Thus, in some cases, the text-to-file editing system receives a user request for editing a digital file and implements an editing workflow that has been aligned with the intent of the user request via one or more rounds of self-correction. Additionally, in some instances, the text-to-file editing system uses API encapsulation when generating and/or revising the executable code to prevent the language machine learning model from accessing certain information.

To illustrate, in one or more embodiments, the text-to-file editing system receives, from a client device, a user request for modifying a digital file. The text-to-file editing system generates, using a language machine learning model, a task plan having formatted code that indicates one or more application programming interface (API) calls to execute to modify the digital file in accordance with the user request. The text-to-file editing system further generates, via one or more code verifications on the formatted code, an error log that identifies one or more errors in the task plan. Using the language machine learning model, the text-to-file editing system generates, from the error log, a corrected task plan that corrects the one or more errors. The text-to-file editing system provides, for display on the client device, a modified digital file generated through execution of the corrected task plan.

As just indicated, in one or more embodiments, the text-to-file editing system modifies a digital file in accordance with a user request. In some cases, the text-to-file editing system modifies the digital file using an editing application. For instance, in some embodiments, the text-to-file editing system executes one or more application programming interface calls to apply one or more corresponding editing tools of an editing application to modify the digital file.

For example, as mentioned, in one or more embodiments, the text-to-file editing system uses a language machine learning model to generate a task plan that indicates one or more application programming interface calls to execute to modify the digital file. For instance, in some cases, the task plan indicates application programming interface calls to execute in sequence and/or application programming interface calls to execute in parallel. In certain implementations, the text-to-file editing system generates the task plan using a particular code formatting.

Further, in some embodiments, the text-to-file editing system uses the language machine learning model to generate a corrected task plan from the task plan. Indeed, in some instances, the text-to-file editing system detects one or more errors within the task plan via one or more code verifications. Thus, in some embodiments, the text-to-file editing system revises the task plan to correct the detected error(s). In some cases, the text-to-file editing system generates an error log via the code verification(s) and provides the error log as part of the prompt to the language machine learning model to generate the corrected task plan.

As further mentioned, in one or more embodiments, the text-to-file editing system presents the corrected task plan for display on the client device that submitted the user request. In some cases, the text-to-file editing system receives user feedback and modifies the corrected task plan based on the user feedback. For instance, in some cases, the text-to-file editing system provides the user feedback as part of the prompt to the language machine learning model to modify the corrected task plan.

In one or more embodiments, the text-to-file editing system further uses a language machine learning model to generate and revise executable code for carrying out the corrected task plan (e.g., as modified based on the user feedback). In some cases, the text-to-file editing system uses API encapsulation to prevent the language machine learning model from accessing sensitive information, such as the underlying functionality of the editing tools being applied. Additionally, in certain instances, the text-to-file editing system implements one or more guardrails to ensure smooth execution of the resulting code.

Thus, in some implementations, the text-to-file editing system executes corrected executable code to modify the digital file. By executing the corrected executable code, the text-to-file editing system executes one or more API calls of the editing application to apply one or more corresponding editing tools to the digital file. In some instances, the text-to-file editing system provides the modified digital file for display on the client device that submitted the user request.

As mentioned above, conventional file editing systems suffer from several technological shortcomings that result in inefficient, inflexible, and inaccurate operation. To illustrate, many conventional systems are inefficient in that they require a significant number of user interactions to modify a digital file. In particular, many conventional systems offer a robust set of powerful editing tools that enable various changes to a digital file. Often, more tools are added over time to provide additional editing options. By offering many different tools, however, these conventional systems often complicate the editing process. For instance, such conventional systems often require a significant number of user interactions with a graphical user interface to navigate windows, menus, and sub-menus to locate a desired tool. Some of these systems require additional user interactions to adjust the settings of a selected tool and to apply and fine-tune the application of the tool.

Additionally, conventional file editing systems fail to operate flexibly. For instance, some conventional systems generate workflows that guide the editing process but are inflexible in that they fail to manage errors in the workflows. Indeed, these systems often produce flawed workflows, such as workflows using the wrong editing tools, workflows that call for non-existent tools, or workflows incorporating cyclic dependencies that render the workflows unusable. Such systems often rely on manual user correction or user input providing instruction on the corrections to be made; otherwise, these systems move forward with executing the flawed workflows.

In addition to problems with inefficiency and inflexibility, conventional file editing systems also experience problems with inaccuracy. For instance, by executing flawed workflows, conventional systems fail to produce modified files that accurately reflect the editing intent of the user. In some instances, the workflow itself cannot be fully executed (e.g., where the workflow relies on cyclic dependencies). Even those systems that incorporate user-based corrections still often fail to accurately modify digital files in accordance with the editing intent as they are subject to user error.

One or more embodiments of the text-to-file editing system provide several advantages over conventional systems. For example, one or more embodiments of the text-to-file editing system improve the efficiency of implementing computing devices when compared to conventional systems. For example, by modifying a digital file based on a user request, the text-to-file editing system reduces the number of user interactions that are required to obtain an editing result. Indeed, rather than require user interactions for navigating a graphical user interface and configuring and applying a selected editing tool, the text-to-file editing system performs various behind-the scenes operations—such as generating and revising a task plan and/or executable code—that result in the automated modification of a digital file.

Additionally, one or more embodiments of the text-to-file editing system improve the flexibility of implementing computing devices when compared to conventional systems. In particular, one or more embodiments of the text-to-file editing system flexibly implement self-correction. For instance, by generating error logs and revising task plans and/or executable code to eliminate errors identified by the error logs, embodiments of the text-to-file editing system more flexibly manage flaws present within workflows. Indeed, embodiments of the text-to-file editing system implement a flexible, self-directed process for detecting and removing errors.

Further, one or more embodiments of the text-to-file editing system improve the accuracy of implementing computing devices when compared to conventional systems. In particular, embodiments of the text-to-file editing system provide workflows and modified digital files that more accurately reflect the editing intent of user requests. For instance, by implementing self-directed revision of task plans and/or executable code, embodiments of the text-to-file editing system facilitate the modification of digital files that align more closely to the intended modifications indicated by the user requests.

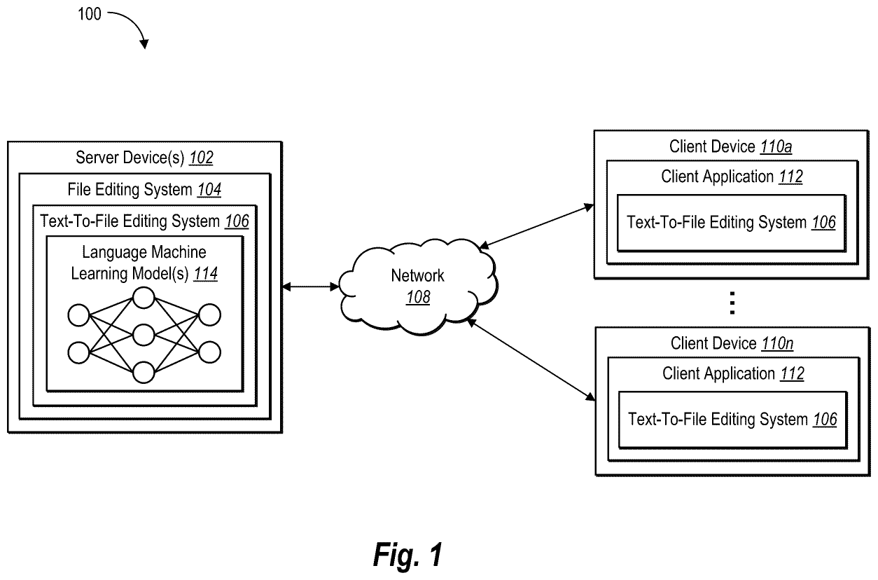

Additional details regarding the text-to-file editing system will now be provided with reference to the figures. For example, FIG. 1 illustrates a schematic diagram of an exemplary system environment (“environment”) 100 in which a text-to-file editing system 106 operates. As illustrated in FIG. 1, the environment 100 includes a server device(s) 102, a network 108, and client devices 110a-110n.

Although the environment 100 of FIG. 1 is depicted as having a particular number of components, the environment 100 is capable of having any number of additional or alternative components (e.g., any number of server devices, client devices, or other components in communication with the text-to-file editing system 106 via the network 108). Similarly, although FIG. 1 illustrates a particular arrangement of the server device(s) 102, the network 108, and the client devices 110a-110n, various additional arrangements are possible.

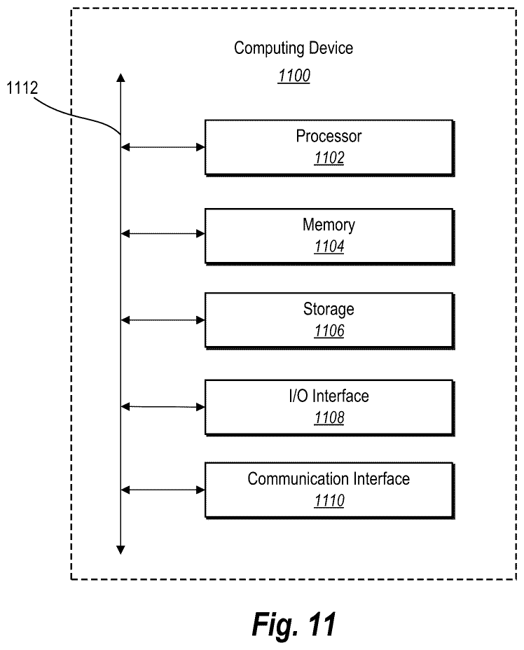

The server device(s) 102, the network 108, and the client devices 110a-110n are communicatively coupled with each other either directly or indirectly (e.g., through the network 108 discussed in greater detail below in relation to FIG. 11). Moreover, the server device(s) 102 and the client devices 110a-110n include one of a variety of computing devices (including one or more computing devices as discussed in greater detail with relation to FIG. 11).

As mentioned above, the environment 100 includes the server device(s) 102. In one or more embodiments, the server device(s) 102 generates, stores, receives, and/or transmits data including digital files and modified digital files. In one or more embodiments, the server device(s) 102 comprises a data server. In some implementations, the server device(s) 102 comprises a communication server or a web-hosting server.

In one or more embodiments, the file editing system 104 provides functionality by which a client device (e.g., a user of one of the client devices 110a-110n) generates, edits, manages, and/or stores digital files. For example, in some instances, a client device sends a digital file to the file editing system 104 hosted on the server device(s) 102 via the network 108. The file editing system 104 then provides many options that are usable by the client device to edit the digital file, store the digital file, and subsequently search for, access, and view the digital file. For instance, in some cases, the file editing system 104 provides one or more options that are usable by the client device to modify a digital file via submission of a user request.

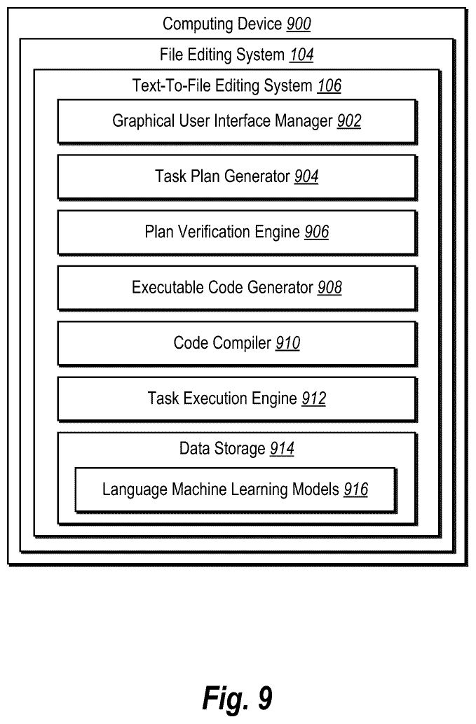

Additionally, the server device(s) 102 include the text-to-file editing system 106. In one or more embodiments, via the server device(s) 102, the text-to-file editing system 106 modifies a digital file in accordance with a user request. For instance, in some cases, the text-to-file editing system 106, via the server device(s) 102, uses one or more language machine learning models to generate and revise a task plan for modifying the digital file based on the user request. Via the server device(s) 102, the text-to-file editing system 106 further uses the language machine learning model(s) to generate and revise executable code from the task plan. The text-to-file editing system 106, via the server device(s) 102, executes the executable code to produce the modified digital file. Example components of the text-to-file editing system 106 will be described below with regard to FIG. 9.

In one or more embodiments, the client devices 110a-110n include computing devices that that are capable of accessing, modifying, and/or storing digital files, including modified digital files. For example, in some embodiments, the client devices 110a-110n include smartphones, tablets, desktop computers, laptop computers, head-mounted-display devices, or other electronic devices. In some instances, the client devices 110a-110n include one or more applications (e.g., the client application 112) that are capable of accessing, modifying, and/or storing digital files, including modified digital files. For example, in some embodiments, the client application 112 includes a software application installed on the client devices 110a-110n. In other cases, however, the client application 112 includes a web browser or other application that accesses a software application hosted on the server device(s) 102.

One or more embodiments of the text-to-file editing system 106 are implemented in whole, or in part, by the individual elements of the environment 100. Indeed, as shown in FIG. 1, one or more embodiments of the text-to-file editing system 106 are implemented with regard to the server device(s) 102 and/or at the client devices 110a-110n. In particular embodiments, the text-to-file editing system 106 on the client devices 110a-110n comprises a web application, a native application installed on the client devices 110a-110n (e.g., a mobile application, a desktop application, a plug-in application, etc.), or a cloud-based application where part of the functionality is performed by the server device(s) 102.

In additional or alternative embodiments, the text-to-file editing system 106 on the client devices 110a-110n represents and/or provides the same or similar functionality as described herein in connection with the text-to-file editing system 106 on the server device(s) 102. In some implementations, the text-to-file editing system 106 on the server device(s) 102 supports the text-to-file editing system 106 on the client devices 110a-110n.

For example, in some embodiments, the text-to-file editing system 106 on the server device(s) 102 trains one or more machine learning models described herein (e.g., the language machine learning model(s) 114). The text-to-file editing system 106 on the server device(s) 102 provides the one or more trained machine learning models to the text-to-file editing system 106 on the client devices 110a-110n for implementation. Accordingly, although not illustrated, in one or more embodiments, the text-to-file editing system 106 on the client devices 110a-110n uses the one or more trained machine learning models to generate workflows and modify digital files independent from the server device(s) 102.

In some embodiments, the text-to-file editing system 106 includes a web hosting application that allows the client devices 110a-110n to interact with content and services hosted on the server device(s) 102. To illustrate, in one or more implementations, the client devices 110a-110n accesses a web page or computing application supported by the server device(s) 102. The client devices 110a-110n provide input to the server device(s) 102, such as a digital file and a user request for modifying the digital file. In response, the text-to-file editing system 106 on the server device(s) 102 utilizes the provided input to modify the digital file. The server device(s) 102 then provides the modified digital file to the client devices 110a-110n.

In some embodiments, though not illustrated in FIG. 1, the environment 100 has a different arrangement of components and/or has a different number or set of components altogether. For example, in certain embodiments, the client devices 110a-110n communicate directly with the server device(s) 102 bypassing the network 108. As another example, the environment 100 includes a third-party server device comprising a content server and/or a data collection server.

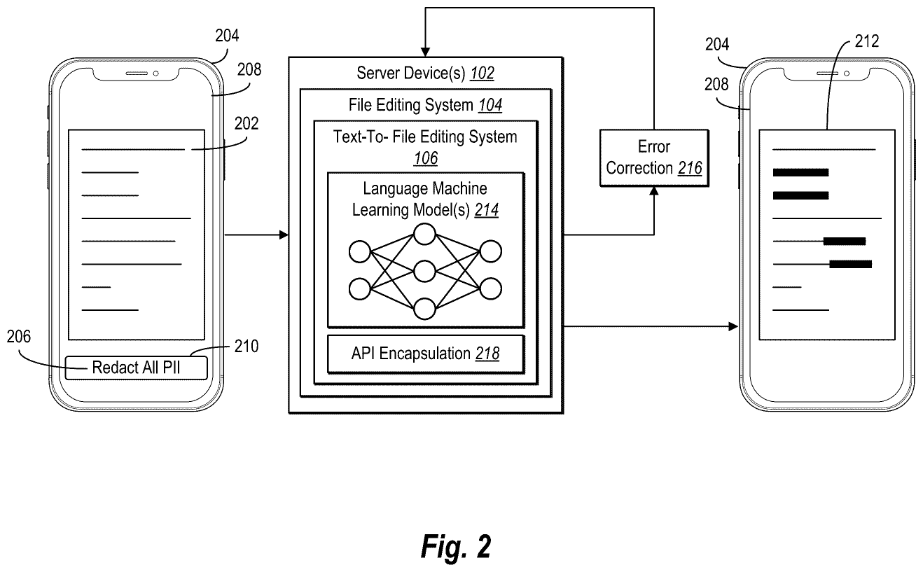

As mentioned, in one or more embodiments, the text-to-file editing system 106 modifies a digital file in response to receiving a user request. In particular, in some embodiments, the text-to-file editing system 106 edits the digital file in accordance with the editing intent indicated by the user request. FIG. 2 illustrates the text-to-file editing system 106 editing a digital file in response to a user request in accordance with one or more embodiments.

As shown in FIG. 2, the text-to-file editing system 106 receives a digital file 202 from a client device 204. In one or more embodiments, a digital file includes a file containing and/or created from digital data. For instance, in some embodiments, a digital file includes a file containing a digital image, digital audio, digital video, and/or text. Indeed, in some cases, a digital file includes a file having multiple forms of digital media. In some instances, however, a digital file includes a file having a single form of digital media, such as a text file or an image file. In some implementations, a digital file is associated with a particular format, including but not limited to JPEG, GIF, DOC, HTML, ASC, MSG, TXT, or PDF.

In one or more embodiments, as shown, the client device 204 is a separate device from the server device(s) 102 upon which the text-to-file editing system 106 operates. As such, in some cases, the text-to-file editing system 106 receives the digital file 202 from an external source. In some embodiments, rather than receiving the digital file 202 from the client device 204, the text-to-file editing system 106 receives a location of the digital file 202 from the client device 204, such as a location on a remote server storing the digital file 202. Accordingly, in certain instances, the text-to-file editing system 106 retrieves the digital file 202 from the received location. Further, in some implementations, the text-to-file editing system 106 operates on the computing device storing the digital file 202. As such, in one or more embodiments, the text-to-file editing system 106 receives the digital file 202 from another system operating on the computing device or retrieves the digital file 202 from local storage.

Additionally, as shown in FIG. 2, the text-to-file editing system 106 receives a user request 206 for modifying the digital file 202 from the client device 204. In one or more embodiments, a user request includes input requesting or providing instructions for modifying a digital file. In particular, in some cases, a user request includes input indicating one or more modifications to be performed on a digital file. For instance, in some embodiments, a user request includes natural language text input indicating one or more modifications to be performed on a digital file. Indeed, in certain cases, a user request is associated with, expresses, or implies an editing intent (e.g., one or more modifications for the digital file that are intended by the user request).

To illustrate, in one or more embodiments, the text-to-file editing system 106 provides, within a graphical user interface 208 of the client device 204, a text box 210 for entering the user request 206. Thus, in some cases, the text-to-file editing system 106 receives the user request 206 via user input provided through the text box 210. The text-to-file editing system 106, however, uses various methods for entering a user request in various embodiments. For example, in some implementations, the text-to-file editing system 106 provides a drop-down menu or one or more check boxes for selecting from among available modifications.

As further illustrated by FIG. 2, the text-to-file editing system 106 generates a modified digital file 212 from the digital file 202. In particular, the text-to-file editing system 106 modifies the digital file 202 in accordance with the user request 206 to generate the modified digital file 212. For instance, in some cases, the text-to-file editing system 106 uses one or more editing tools of an editing application to modify the digital file 202 via one or more modifications indicated by the user request 206. As shown, the text-to-file editing system 106 provides the modified digital file 212 for display on the graphical user interface 208 of the client device 204.

As further shown, the text-to-file editing system 106 uses one or more language machine learning models 214 to generate the modified digital file 212. In one or more embodiments, a machine learning model includes a computer-implemented model that can be tuned (e.g., trained) based on inputs to approximate unknown functions. In particular, in some embodiments, a machine-learning model includes a model that utilizes algorithms to learn from, and make predictions on, known data by analyzing the known data to learn to generate outputs that reflect patterns and attributes of the known data. For instance, in some cases, a machine-learning model includes, but is not limited to, a neural network (e.g., a convolutional neural network, recurrent neural network or other deep learning network), a decision tree (e.g., a gradient boosted decision tree), association rule learning, inductive logic programming, support vector learning, Bayesian network, regression-based model (e.g., censored regression), principal component analysis, or a combination thereof.

In one or more embodiments, a neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

In one or more embodiments, a language machine learning model includes a computer-implemented machine learning model trained to comprehend and generate human language text. In particular, in some embodiments, a language machine learning model includes a neural network (e.g., a deep neural network) with many parameters trained on large quantities of data (e.g., unlabeled text) using a particular learning technique (e.g., self-supervised learning). For example, in some cases, a language machine learning model includes parameters trained to generate natural language text output from natural language text input. In certain implementations, a language machine learning model includes a large language model. Some examples of large language models include, but are not limited to, chat generative pre-trained transformer (Chat GPT), Gemini, and Large Language Model Meta AI (LLaMA).

As will be discussed below, in some cases, the text-to-file editing system 106 uses the one or more language machine learning models 214 to generate the modified digital file 212 by using the one or more language machine learning models 214 to generate a task plan and/or executable code for modifying the digital file 202. Further, in some instances, the text-to-file editing system 106 uses the one or more language machine learning models 214 to revise the task plan and/or executable code.

Indeed, as indicated by FIG. 2, the text-to-file editing system 106 uses error correction 216 in generating the modified digital file 212. In particular, in some cases, the text-to-file editing system 106 detects one or more errors in the task plan and/or executable code generated by the one or more language machine learning models 214. In some cases, the text-to-file editing system 106 generates an error log identifying the detected error(s). Thus, in certain embodiments, the text-to-file editing system 106 uses the one or more language machine learning models 214 to revise the task plan and/or executable code by correcting the detected error(s). In some implementations, the text-to-file editing system 106 uses multiple iterations of the error correction 216 to produce a task plan and/or executable code that is satisfactory (e.g., without error or, at least, satisfies the verifications used for error detection).

As shown, the text-to-file editing system 106 further uses API encapsulation 218 when generating the modified digital file 212. In particular, in some cases, the text-to-file editing system 106 uses the API encapsulation 218 when generating and/or revising executable code via the one or more language machine learning models 214. In some instances, as will be discussed below, the text-to-file editing system 106 uses the API encapsulation 218 to prevent the one or more language machine learning models 214 from accessing sensitive information, such as the underlying functionality of the editing tools to be applied via the executable code.

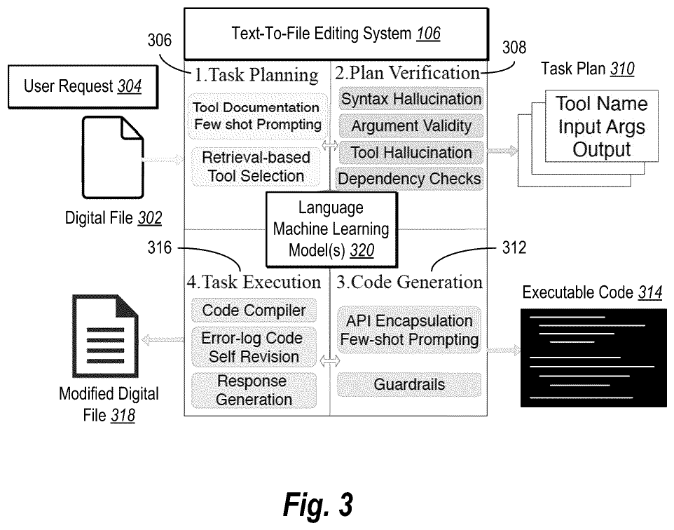

As mentioned, one or more embodiments of the text-to-file editing system 106 modify a digital file in accordance with a user request. In particular, one or more embodiments of the text-to-file editing system 106 employs various processes or steps to modify the digital file. FIG. 3 illustrates the text-to-file editing system 106 employing various processes or steps in modifying a digital file in accordance with one or more embodiments. The below discussion with reference to FIG. 3 provides a high-level overview of the processes or steps implemented by the text-to-file editing system 106, and further detail will be provided with respect to subsequent figures.

Indeed, as shown in FIG. 3, the text-to-file editing system 106 receives a digital file 302 and a user request 304 for modifying the digital file 302. Further, as shown, the text-to-file editing system 106 employs a task planning process 306 and a plan verification process 308 to generate a task plan 310 for modifying the digital file 302 in accordance with the user request 304.

Indeed, in one or more embodiments, a task plan includes a plan for completing a modification task for a digital file. In particular, in some embodiments, a task plan includes a plan for modifying a digital file in accordance with a user request. To illustrate, in some cases, a task plan includes a plan for modifying a digital file using one or more modifications explicitly or implicitly indicated by a user request. In some cases, a task plan indicates one or more tools of an editing application to employ in applying the one or more modifications to the digital file. In certain embodiments, the task plan indicates one or more application programming interface calls to execute in modifying the digital file, such as one or more application programming interface calls associated with one or more tools of an editing application. In certain implementations, a task plan includes an order of tools (e.g., application programming interface calls) to use.

In one or more embodiments, an editing application includes a software application for editing digital files. In particular, in some embodiments, an editing application includes a software application that provides a collection of various tools or features that are usable for modifying digital files. Indeed, in some cases, an editing application provides tools and features for performing editing actions with respect to digital files by invoking corresponding editing operations of the editing application. In certain implementations, an editing application provides a user interface (e.g., a graphical user interface) through which a user selects, configures, and/or applies one or more of the provided tools or features for modifying files. In some cases, an editing application provides an application programming interface through which another software application selects, configures, and/or applies one or more of the provided tools. In some instances, upon application of a select tool or feature, the editing application operates in the background using one or more editing operations to modify the digital file.

In one or more embodiments, an application programming interface (API) call includes a software-based request to access a service, function, or feature of a software application. In particular, in some embodiments, an API call includes a software-based request submitted by a first software application or system to a second software application or system, requesting access to a service, function, or feature of the second software application or system. To illustrate, in some cases, an API call includes a software-based request submitted to an editing application to use one or more tools or other features of the editing application to modify a digital file.

As further shown in FIG. 3, the text-to-file editing system 106 employs a code generation process 312 to generate executable code 314 for modifying the digital file 302 in accordance with the user request 304. In one or more embodiments, executable code includes code that is executable via a software application. For instance, in some embodiments, executable code includes code that is executable via an editing application to perform one or more edits on a digital file. In particular, in certain cases, executable code includes code that, when executed via an editing application, invokes one or more editing operations of the editing application to perform one or more corresponding edits with respect to a digital file. For instance, in some cases, executable code includes one or more code segments that are compatible with an editing application in that the one or more code segments are written in the code language of the editing application or another compatible language and/or are formatted/structured in accordance with the rules of that language and/or the editing application. In some embodiments, executable code includes one or more API calls that are associated with (e.g., invoke or request access to) one or more tools of an editing application. Indeed, in some cases, executable action code invokes one or more editing operations of an editing application by, when executed, invoking or otherwise requesting the use of one or more tools of the editing application that perform the editing operation(s).

In some embodiments, the text-to-file editing system 106 generates the executable code 314 to modify the digital file 302 in accordance with the task plan 310. For instance, in some cases, the text-to-file editing system 106 generates the executable code 314 to include the one or more API calls that are indicated by the task plan 310.

Additionally, as shown in FIG. 3, the text-to-file editing system 106 employs a task execution process 316. In particular, the text-to-file editing system 106 uses the task execution process 316 to generate a modified digital file 318. For instance, in some cases, the text-to-file editing system 106 uses the task execution process 316 to execute the executable code 314 to modify the digital file 302 and produce the modified digital file 318. As will be discussed further below, in some cases, the text-to-file editing system 106 further revises the executable code 314 before execution.

As further indicated in FIG. 3, the text-to-file editing system 106 uses one or more language machine learning models 320, such as one or more large language models, in employing the task planning process 306, the plan verification process 308, the code generation process 312, and/or the task execution process 316. For instance, as will be described further below, in some cases, the text-to-file editing system 106 uses the one or more language machine learning models 320 to generate and/or revise the task plan and/or the executable code.

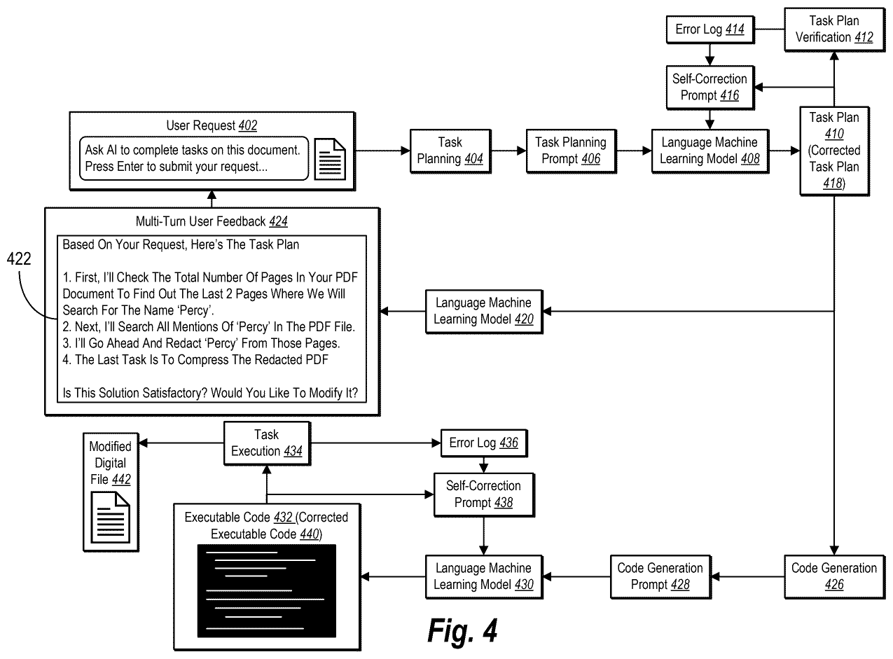

FIG. 4 illustrates more detail regarding the processes discussed above with reference to FIG. 3 in accordance with one or more embodiments. In particular, FIG. 4 illustrates how the processes operate and interact to modify a digital file based on a user request in accordance with one or more embodiments.

FIG. 4 illustrates an overview of the operation of and interaction between processes employed by the text-to-file editing system 106 in accordance with one or more embodiments. Indeed, as shown in FIG. 4, the text-to-file editing system 106 provides a user request 402 (shown here as including a digital file to be modified) to a task planning process 404. The text-to-file editing system 106 uses the task planning process 404 to generate a task planning prompt 406.

In one or more embodiments, a task planning prompt includes a prompt for generating a task plan. In particular, in some cases, a task planning prompt includes a prompt for generating a task plan to modify a digital file in accordance with a user request. A task planning prompt includes various sets of information in various embodiments, and information included in one or more embodiments will be discussed further below. In some cases, a task planning prompt includes a prompt provided to a language machine learning model (e.g., a large language model) for the generation of a task plan.

Indeed, as shown in FIG. 4, the text-to-file editing system 106 provides the task planning prompt 406 to a language machine learning model 408. The text-to-file editing system 106 uses the language machine learning model 408 to generate a task plan 410 based on the task planning prompt 406. The text-to-file editing system 106 further uses a plan verification process 412 to verify the task plan 410. In particular, the text-to-file editing system 106 uses the plan verification process 412 to perform one or more code verifications on the task plan 410. Indeed, in one or more embodiments, the task plan 410 includes formatted code, and the text-to-file editing system 106 uses the plan verification process 412 to perform one or more code verifications on the formatted code.

In one or more embodiments, formatted code includes code and/or pseudo-code having a particular format. In particular, in some embodiments, formatted code includes one or more segments of code and/or pseudo-code for performing one or more tasks. To illustrate, in some cases, formatted code includes code and/or pseudo-code included in a task plan for modifying a digital file in accordance with a user request. For example, in some instances, formatted code includes code and/or pseudo-code that indicates one or more API calls to execute in modifying a digital file (e.g., by indicating the functionality of the tool associated with each API call, the one or more input arguments to be included in each API call, and/or the one or more return values of each API call). In certain embodiments, formatted code is not executable via a software application; rather, formatted code is readable text. In other words, in some implementations, a file containing formatted code is a readable text file rather than an executable file. For example, in certain embodiments, formatted code includes Java Script Object Notation (JSON) text or Extensible Markup Language (XML) text.

In one or more embodiments, a code verification includes a process for checking or otherwise verifying the suitability of code. In particular, in some embodiments, a code verification includes a process for checking or otherwise verifying the suitability of formatted code in a task plan. In certain cases, a code verification checks or otherwise verifies a particular characteristic of the formatted. For example, in some cases, a code verification includes an inter-task dependency verification for checking the suitability of the dependencies between API calls indicated within formatted code. To illustrate, in some instances, a code verification includes a check for dependency hallucination or dependency consistency within the formatted code. In other cases, a code verification includes a static composition verification for checking the suitability of the contents of the formatted code. To illustrate, in certain cases, a code verification includes a check for syntax hallucination, tool hallucination, or argument validity within the formatted code.

As shown in FIG. 4, the text-to-file editing system 106 generates an error log 414 based on the one or more code verifications performed via the plan verification process 412. In one or more embodiments, an error log 414 includes a log indicate one or more errors identified within code. For instance, in some cases, an error log includes one or more errors identified within the formatted code of a task plan via one or more code verifications on the formatted code. In some instances, however, an error log includes one or more errors identified within executable code via simulation of executable code.

As further shown, the text-to-file editing system 106 uses the error log 414 to generate a self-correction prompt 416. In one or more embodiments, a self-correction prompt includes a prompt for revising or otherwise correcting a task plan or executable code. In particular, in some cases, a self-correction prompt includes a prompt for correcting a task plan or executable code by removing one or more errors detected therein. A self-correction prompt includes various sets of information in various embodiments. In some cases, a self-correction prompt includes a prompt provided to a language machine learning model (e.g., a large language model) for the revision of the task plan or executable code.

Indeed, as shown in FIG. 4, the text-to-file editing system 106 provides the self-correction prompt 416 to the language machine learning model 408. In particular, the self-correction prompt 416 includes the error log 414 and the task plan 410 (or data generated from the error log 414 and the task plan 410). Using the language machine learning model 408, the text-to-file editing system 106 revises or corrects the task plan 410 based on the self-correction prompt 416. In particular, the text-to-file editing system 106 generates a corrected task plan 418.

In one or more embodiments, a corrected task plan includes a revised task plan having one or more errors contained therein removed. In particular, in some embodiments, a corrected task plan includes a revision to a task plan that corrects at least one error that was detected within the task plan. For instance, in some cases, a corrected task plan includes a revision to a task plan that corrects at least one error identified from an error log generated for the task plan.

As illustrated in FIG. 4, the text-to-file editing system 106 provides the corrected task plan 418 to the plan verification process 412 for further verification. Indeed, the text-to-file editing system 106 uses the plan verification process 412 to determine whether at least one error remains within corrected task plan 418 (e.g., an error originally in the task plan 410 or a new error introduced during the revision). In some cases, upon detecting at least one error, the text-to-file editing system 106 generates an additional error log and uses the language machine learning model 408 to further revise the corrected task plan 418. Thus, in certain embodiments, the text-to-file editing system 106 revises the task plan 410 via an iterative process until zero errors have been detected.

As shown by FIG. 4, upon generating the corrected task plan 418 (e.g., a revised version of the task plan 410 that includes zero errors based on the one or more code verifications performs), the text-to-file editing system 106 presents the corrected task plan 418. In particular, the text-to-file editing system 106 presents the corrected task plan 418 to the client device that submitted the user request 402. For instance, as shown, the text-to-file editing system 106 provides the corrected task plan 418 to a language machine learning model 420 (e.g., a different model than the model used to generate the corrected task plan 418 or the same model). Using the language machine learning model 420, the text-to-file editing system 106 generates a description 422 (e.g., an explanation in natural language text) of the corrected task plan 418. The text-to-file editing system 106 provides this description 422 for display on the client device that submitted the user request 402.

In some cases, the text-to-file editing system 106 receives feedback regarding the corrected task plan 418 via the client device based on the description 422 that was presented. In certain cases, the text-to-file editing system 106 uses the feedback to further modify the corrected task plan 418. For instance, in some cases, the text-to-file editing system 106 provides the feedback to the task planning process 404 to facilitate the generation of the modified task plan as described above with respect to generating the corrected task plan 418. In some embodiments, the text-to-file editing system 106 iteratively modifies the corrected task plan 418 based on received user feedback. Thus, as indicated in FIG. 4, some embodiments of the text-to-file editing system 106 employ multi-turn user feedback 424 for revising a corrected task plan based on user feedback. In some cases, the text-to-file editing system 106 revises a corrected task plan until receiving an indication via the client device that the corrected task plan is satisfactory.

As further shown in FIG. 4, the text-to-file editing system 106 provides the corrected task plan 418 (e.g., a version indicated as satisfactory via the multi-turn user feedback 424) to the code generation process 426. Using the code generation process 426, the text-to-file editing system 106 generates a code generation prompt 428.

In one or more embodiments, a code generation prompt includes a prompt for generating executable code. In particular, in some cases, a code generation prompt includes a prompt for generating executable code that, when executed, modifies a digital file in accordance with a task plan (e.g., a corrected task plan). A code generation prompt includes various sets of information in various embodiments, and information included in one or more embodiments will be discussed further below. In some cases, a code generation prompt includes a prompt provided to a language machine learning model (e.g., a large language model) for the generation of executable code.

Indeed, as shown, the text-to-file editing system 106 provides the code generation prompt 428 to a language machine learning model 430 (the same model as or a different model from the models discussed above). Using the language machine learning model 430, the text-to-file editing system 106 generates executable code 432 based on the code generation prompt 428.

As shown, the text-to-file editing system 106 provides the executable code 432 to a task execution process 434 and uses the task execution process 434 to verify the suitability of the executable code 432 for execution. As indicated, upon detecting one or more errors in the executable code 432, the text-to-file editing system 106 generates an error log 436 indicating the error(s). The text-to-file editing system 106 further generates a self-correction prompt 438 from the error log 436 and the executable code 432 and uses the language machine learning model 430 to generate corrected executable code 440 based on the self-correction prompt 438.

In one or more embodiments, corrected executable code includes revised executable code having one or more errors contained therein removed. In particular, in some embodiments, corrected executable code includes a revision to executable code that corrects at least one error that was detected within the executable code. For instance, in some cases, corrected executable code includes a revision to executable code that corrects at least one error identified from an error log generated for the executable code.

As illustrated in FIG. 4, the text-to-file editing system 106 provides the corrected executable code 440 to the task execution process 434. The text-to-file editing system 106 uses the task execution process 434 to determine whether at least one error remains within corrected executable code 440 (e.g., an error originally in the executable code 432 or a new error introduced during the revision). In some cases, upon detecting at least one error, the text-to-file editing system 106 generates an additional error log and uses the language machine learning model 430 to further revise the corrected executable code 440. Thus, in certain embodiments, the text-to-file editing system 106 revises the executable code 432 via an iterative process until zero errors have been detected.

As further illustrated, the text-to-file editing system 106 uses the task execution process 434 to execute the executable code 432 (e.g., a revised version of the executable code 432 that includes zero errors). Upon executing the executable code 432, the text-to-file editing system 106 generates a modified digital file 442 in accordance with the user request 402.

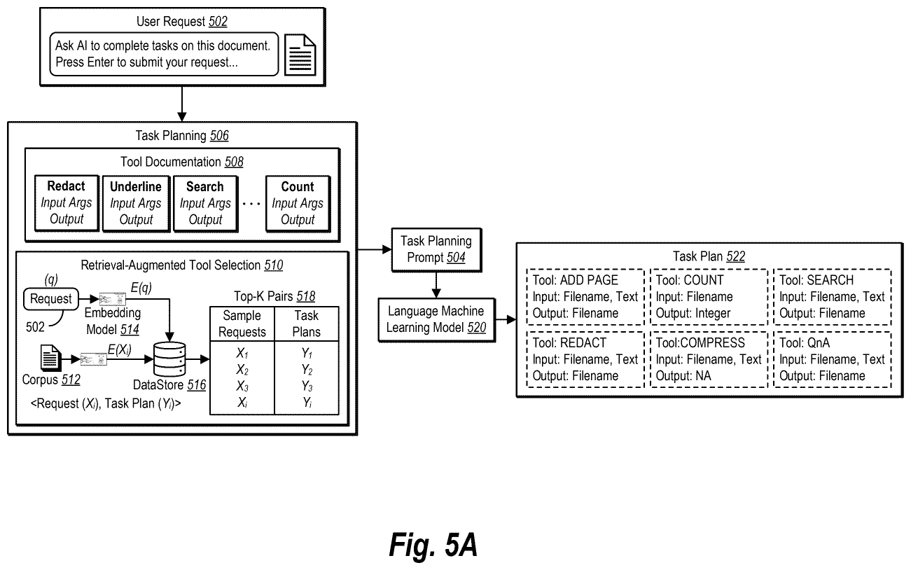

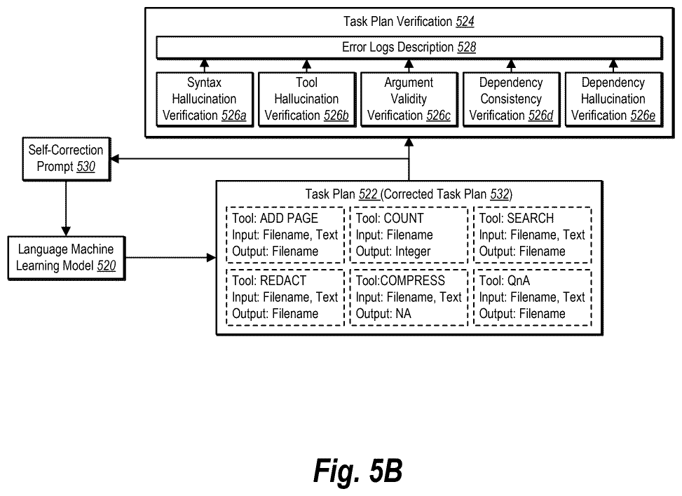

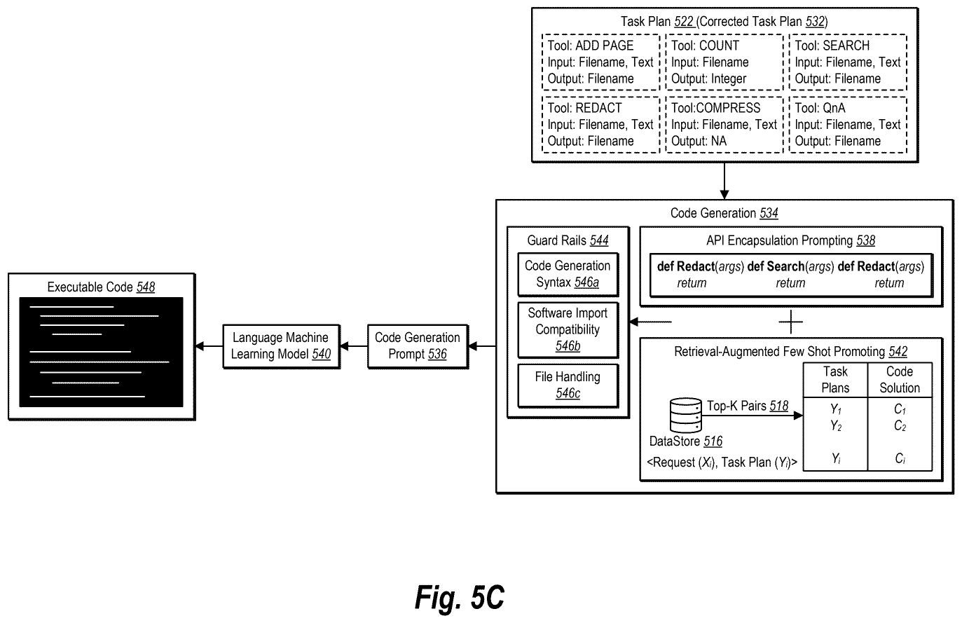

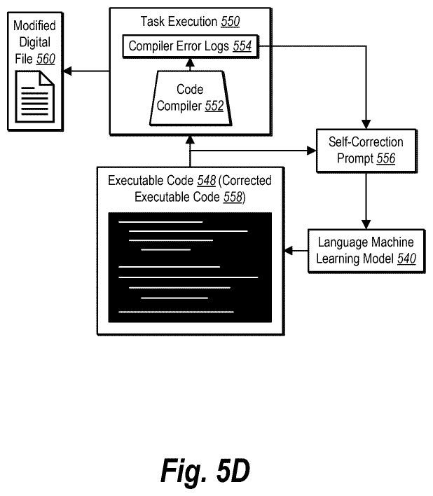

FIGS. 5A-5D illustrate more detail regarding the processes discussed above with reference to FIG. 4 in accordance with one or more embodiments. For instance, FIG. 5A illustrates the text-to-file editing system 106 using a task planning process to generate a task plan from a user request in accordance with one or more embodiments. Indeed, as shown in FIG. 5A, and as discussed above, the text-to-file editing system 106 receives a user request 502 (shown here as including a digital file to be modified) and generates a task planning prompt 504 from the user request 502 using a task planning process 506.

As shown in FIG. 5A, the text-to-file editing system 106 generates the task planning prompt 504 using tool documentation 508. In one or more embodiments, the tool documentation 508 includes information for the set of tools (e.g., the set of all tools or a subset of tools) available from the editing application to be used in modifying the digital file. In one or more embodiments, the text-to-file editing system 106 generates the task planning prompt 504 from the tool documentation 508 or otherwise includes the tool documentation 508 in the task planning prompt 504. Thus, in some embodiments, the task planning prompt 504 indicates at least one application programming interface call associated with at least one tool from the set of tools of the editing application.

As further shown in FIG. 5A, the text-to-file editing system 106 generates the task planning prompt 504 using retrieval-augmented tool selection 510. In particular, in some embodiments, the text-to-file editing system 106 generates the task planning prompt 504 to include one or more relevant examples a task plan generated from a user request.

To illustrate, as shown in FIG. 5A, the text-to-file editing system 106 maintains a corpus 512 of examples including sample pairs. In one or more embodiments, each sample pair in the corpus 512 includes a sample user request (represented as xᵢ) and a sample task plan (represented as yᵢ) that corresponds to the sample user request. For instance, in some cases, a sample user request includes a user request previously received from a client device, and the sample task plan includes a task plan that was implemented in response to the sample user request. In some implementations, a sample user request includes a user request designed (e.g., by an engineer or administrator) for inclusion within the corpus 512, and the sample task plan includes a task plan designed to modify a digital file based on the editing intent of the sample user request.

As further shown, the text-to-file editing system 106 uses an embedding model 514 to generate a sample request embedding (represented as E(xᵢ)) for each of one or more of the sample user requests of the corpus 512. In some cases, the embedding model 514 includes a text embedding model. In one or more embodiments, by generating the sample request embedding(s), the text-to-file editing system 106 creates a datastore 516 with keys as vectorized sample requests and values as ground truth sample task plans.

Additionally, as shown in FIG. 5A, the text-to-file editing system 106 generates a request embedding (represented as E(q)) for the user request 402 (represented as q). Using the request embedding, the text-to-file editing system 106 determines one or more sample pairs represented in the datastore 516 to use in generating the task planning prompt 504. For instance, in some cases, the text-to-file editing system 106 determines one or more sample pairs associated with sample request embeddings that are closest to the request embedding within the embedding space. In certain implementations, as indicated in FIG. 5A, the text-to-file editing system 106 determines the top-k sample pairs 518 based on the embeddings. To illustrate, in some implementations, the text-to-file editing system 106 uses a k-nearest neighbor technique with a Euclidean distance metric to query the top-k sample requests from the datastore 516 that are semantically most similar to the user request based on their respective embeddings. In one or more embodiments, the text-to-file editing system 106 generates the task planning prompt 504 from the one or more determined sample pairs (e.g., the top-k sample pairs 518) or otherwise includes the one or more determined sample pairs in the task planning prompt 504.

In some embodiments, the text-to-file editing system 106 further includes the user request 502 in the task planning prompt 504. In some implementations, the text-to-file editing system 106 further includes additional or alternative information in the task planning prompt 504. For example, in some cases, the text-to-file editing system 106 includes additional instruction for generating a task plan (e.g., instruction indicating features to exclude or include and/or indicating the particular format to be used in generating the task plan).

As illustrated by FIG. 5A, and as previously discussed, the text-to-file editing system 106 uses a language machine learning model 520 to generate the task plan 522 from the task planning prompt 504. As previously mentioned, in some cases, the task plan 522 includes formatted code indicating one or more API calls to execute to modify the digital file in accordance with the user request or otherwise indicating one or more tools of an editing application to use. For instance, in some cases, the task plan 522 breaks the task of modifying the digital file down into multiple sub-tasks (e.g., with each sub-task referring to an API call to execute and/or a corresponding tool to use). In some cases, the text-to-file editing system 106 uses the task plan 522 to parse the sub-tasks through slot filing. For example, in certain embodiments, the text-to-file editing system 106 represents each sub-task within the task plan 522 using a set of slots indicating a tool function name, a tool function description, a unique identifier, one or more dependencies, one or more arguments, and one or more returned values. In some cases, the text-to-file editing system 106 represents each sub-task using a subset of these slots. Thus, the text-to-file editing system 106 generates the task plan 522 from the user request 502 where the task plan 522 indicates a plan for modifying the digital file indicated by the user request 502.

FIG. 5B illustrates the text-to-file editing system 106 using a plan verification process to verify and/or revise a task plan generated for a user request in accordance with one or more embodiments. Indeed, as shown in FIG. 5B, the text-to-file editing system 106 uses a plan verification process 524 to perform one or more code verifications on the task plan 522 (e.g., on the formatted code of the task plan).

As previously mentioned, in some cases, the text-to-file editing system 106 performs the one or more code verifications by performing one or more static composition verifications. For instance, as shown in FIG. 5B, the text-to-file editing system 106 performs a syntax hallucination verification 526a, a tool hallucination verification 526b, and an argument validity verification 526c. In some cases, by performing the one or more static composition verifications, the text-to-file editing system 106 checks the individual components of the task plan 522.

Further, as mentioned, in some instances, the text-to-file editing system 106 performs the one or more code verifications by performing one or more inter-task dependency verifications. For example, as shown in FIG. 5B, the text-to-file editing system 106 performs a dependency consistency verification 526d and a dependency hallucination verification 526e. In some embodiments, the text-to-file editing system 106 uses the dependency hallucination verification 526e to ensure the language machine learning model 520 does not hallucinate dependencies referencing non-existent or future function calls (e.g., API calls) in the task plan 522.

In certain cases, the text-to-file editing system 106 uses the dependency consistency verification 526d to ensure there are no cyclic dependencies between the intermediate function calls of the task plan 522. Indeed, in some embodiments, one or more function calls of the task plan 522 depend on one or more prior function calls, and some of the dependencies are non-linear. Thus, in certain embodiments, the text-to-file editing system 106 represents the dependencies as a dependency graph. More particularly, in some instances, a function call of the task plan 522 attempts to access resources of another function call. In some instances, however, the dependencies among function calls are cyclic such that a deadlock condition arises during execution of the function calls. Thus, in some implementations, the text-to-file editing system 106 uses the dependency consistency verification 526d to identify cyclic dependencies within the task plan 522 and avoid resource conflicts.

In one or more embodiments, the text-to-file editing system 106 performs the dependency consistency verification 526d by generating a dependency graph having nodes that correspond to the function calls of the task plan 522 and having edges representing the interdependencies among those function calls. The text-to-file editing system 106 determines the presence of cyclic dependencies within the task plan 522 by determining whether the dependency graph includes a directed acyclic graph (where a non-directed acyclic graph indicates the presence of cyclic dependencies). To illustrate, in at least one embodiment, the text-to-file editing system 106 evaluates the dependency graph using Kahn's algorithm by performing a topological sort of the dependency graph followed by a depth-first traversal to determine if all nodes have been visited exactly once without repetition. The text-to-file editing system 106 determines that a violation of this condition indicates a lack of the DAG property. In some embodiments, the text-to-file editing system 106 attributes the violation of the condition to the functional call of the failing node (e.g., the node visited multiple times or the node leading to a repeated visit of a subsequent node).

As shown in FIG. 5B, the text-to-file editing system 106 generates one or more error logs 528 indicating one or more errors detected in the task plan 522 via the one or more code verifications. The text-to-file editing system 106 further generates a self-correction prompt 530 from the one or more error logs 528 and the task plan 522 and uses the language machine learning model 520 to generate a corrected task plan 532 from the self-correction prompt 530. As previously mentioned, the text-to-file editing system 106 uses the plan verification process 524 as part of an iterative process for revising the task plan 522. Thus, the text-to-file editing system 106 generates the corrected task plan 532 from the task plan 522 via one or more code verifications.

FIG. 5C illustrates the text-to-file editing system 106 using a code generation process to generate executable code from a task plan or corrected task plan in accordance with one or more embodiments. Indeed, as shown in FIG. 5C, the text-to-file editing system 106 uses a code generation process 534 to generate a code generation prompt 536 from the task plan 522 (e.g., where no errors are detected) or the corrected task plan 532 (e.g., where one or more errors were detected in the task plan 522 and corrected).

As shown in FIG. 5C, the text-to-file editing system 106 generates the code generation prompt 536 using API encapsulated prompting 538. In other words, the text-to-file editing system 106 generates the code generation prompt 536 by generating an encapsulated code generation prompt. In one or more embodiments, an encapsulated code generation prompt includes a code generation prompt having encapsulated information. In some embodiments, encapsulated information includes information associated with a feature for protecting sensitive information. In particular, in some embodiments, encapsulated information includes limited information that is designed to prevent access to sensitive information. To illustrate, in certain cases, encapsulated information includes top-level information but excludes the corresponding lower-level information to prevent access to the lower-level information.

For instance, in some cases, the text-to-file editing system 106 includes, within the code generation prompt 536, top-level information associated with the API calls indicated by the task plan 522 or the corrected task plan 532 but excludes the associated lower-level information to prevent the language machine learning model 540 from accessing that lower-level information. To illustrate, in some cases, the text-to-file editing system 106 includes the function name, one or more input arguments, and/or one or more return values of an API call but excludes the internal code implementation of the API call. Thus, the text-to-file editing system 106 provides the language machine learning model 540 with an abstracted view of the API call but prevents the language machine learning model 540 from learning or modifying the internal code implementation. In some cases, using an encapsulated code generation prompt as described prevents the problem of function hallucination and ensures that only well-trusted and rigorously tested API functions are used by the language machine learning model 540.

As further shown in FIG. 5C, the text-to-file editing system 106 generates the code generation prompt 536 (e.g., an encapsulated code generation prompt) using retrieval-augmented few shot prompting 542. For instance, in some cases, the text-to-file editing system 106 uses the examples retrieved via the retrieval-augmented tool selection 510 in generating the code generation prompt 536. To illustrate, in some cases, the text-to-file editing system 106 uses additional sample pairs associated with the examples where each additional sample pair includes a sample task plan (yᵢ) that was used during task plan generation and sample executable code (represented as cᵢ) that corresponds to the sample task plan. Indeed, the text-to-file editing system 106 uses the sample executable code as a ground truth code solution for the sample task plan.

Additionally, as illustrated, the text-to-file editing system 106 generates the code generation prompt 536 using one or more guardrails 544. In one or more embodiments, a guardrail includes an instruction included within a prompt designed to prevent an undesirable output. In particular, in some embodiments, a guardrail includes an instruction included within a prompt (e.g., a code generation prompt) to a language machine learning model that is designed to prevent the language machine learning model from generating an undesirable output (e.g., undesirable code within the resulting executable code). For instance, in some cases, a guardrail includes an explicit instruction within a code generation prompt that ensures proper execution of the executable code generated from the code generation prompt.

For instance, as shown in FIG. 5C, the text-to-file editing system 106 uses a first guardrail 546a corresponding to code generation syntax, a second guardrail 546b that corresponds to software import compatibility, and a third guardrail 546c that corresponds to data privacy related file handling. Indeed, in some cases, the text-to-file editing system 106 implements the first guardrail 546a to prevent the problem of lazy assistance (e.g., where the language machine learning model 540 instructs the user on how to solve the problem instead of generating the solution) by including instruction to ensure the language machine learning model 540 produces independently executable code. Further, in some cases, the text-to-file editing system 106 adds explicit instruction that forces the language machine learning model 540 to follow a pre-defined syntax with other extraneous text formatted as comments in the generated code.

In certain embodiments, the text-to-file editing system 106 implements the second guardrail 546b by maintaining a software safe-list of approved software packages, libraries, and/or executable code in the documentation of the API calls, indicating to the language machine learning model 540 what is permitted to be invoked in generating executable code. The text-to-file editing system 106 further incorporates explicit instructions in the code generation prompt that prevents the language machine learning model 540 from generating any overhead software libraries and packages for code execution. In some cases, the text-to-file editing system 106 instructs the language machine learning model 540 to pre-append the software safe-list to the generated code.

In one or more embodiments, the text-to-file editing system 106 implements the third guardrail 546c to prevent exposure of input file names, input types, and/or output files, by strongly type-casting references to input file names, output file names, and/or addresses in the generated code to their actual values at the code execution step. In some instances, the text-to-file editing system 106 imposes strict directory access restrictions that prevent accessing, reading, and/or saving files without explicit user permission. Further, in some embodiments, the text-to-file editing system 106 requires that the code execution step involve creating a copy of all files required as inputs to a temporary directory and saving all intermediate files and the output digital file to avoid overwriting or modifying non-permitted files.

Thus, the text-to-file editing system 106 uses the language machine learning model 540 to generate executable code 548 from the code generation prompt 536 built on encapsulated information, few shot examples of sample task plans and corresponding sample executable code, and/or one or more guardrails.

FIG. 5D illustrates the text-to-file editing system 106 using a task execution process to revise and execute executable code to generate a modified digital file in accordance with one or more embodiments. Indeed, as shown in FIG. 5D, the text-to-file editing system 106 provides the executable code 548 to a task execution process 550.

As shown in FIG. 5D, the text-to-file editing system 106 implements a code compiler 552 as part of the task execution process 550. In particular, the text-to-file editing system 106 uses the code compiler 552 to simulate execution of the executable code 548 to mimic modification of the digital file requested to be edited by the user request 502. In some cases, the text-to-file editing system 106 performs the simulation in a sandbox environment. As shown, based on the simulated execution, the text-to-file editing system 106 generates one or more error logs 554 indicating one or more errors within the executable code 548. For instance, in some cases, the one or more error logs 554 indicates one or more compilation errors captured by the code compiler 552.

As indicated in FIG. 5D, the text-to-file editing system 106 generates a self-correction prompt 556 from the one or more error logs 554 and the executable code 548. The text-to-file editing system 106 uses the language machine learning model 540 to generate corrected executable code 558 from the self-correction prompt 556. The text-to-file editing system 106 further provides the corrected executable code 558 to the code compiler 552 to determine whether one or more errors still exist. Upon determining that at least one error still exists, the text-to-file editing system 106 continues to revise the cod. Upon detecting no errors in the code, the text-to-file editing system 106 uses the corrected executable code 558 to generate a modified digital file 560 having edits applied in accordance with the user request 502. In one or more embodiments, the text-to-file editing system 106 implements multiple iterations of revision before generating executable code having no detectable errors.

Thus, in some embodiments, the text-to-file editing system 106 takes in a user request and a digital file, generates a task plan for modifying the digital file in accordance with the user request, self-corrects the task plan, generates executable code based on the corrected task plan, self-corrects the executable code, and modifies the digital file by executing the corrected executable code.

By modifying digital files in response to user requests, one or more embodiments of the text-to-file editing system 106 provide improved efficiency when compared to conventional systems. For instance, embodiments of the text-to-file editing system 106 reduces the number of user interactions that are typically required in modifying a digital file. By implementing a self-directed process correcting task plans and/or executable code, embodiments of the text-to-file editing system 106 further provides improved flexibility as it handles errors without requiring further user interaction. With this self-directed correction process, embodiments of the text-to-file editing system 106 provide modified digital files that more accurately reflect the editing intent of received user requests.

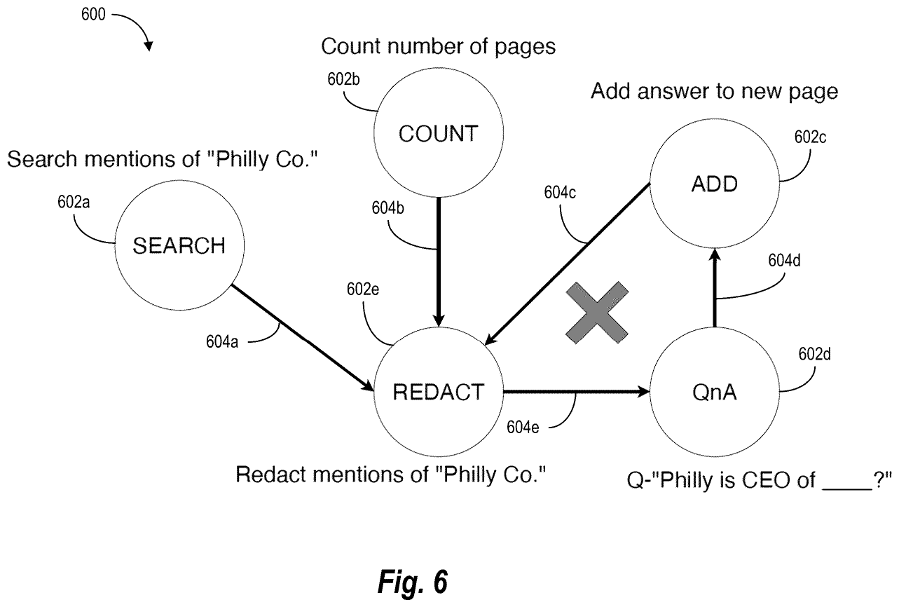

As mentioned, in some embodiments, the text-to-file editing system 106 generates a dependency graph during verification of a generated task plan (or corrected task plan). In particular, the text-to-file editing system 106 generates a dependency graph to perform a dependency consistency verification. FIG. 6 illustrates a dependency graph used by the text-to-file editing system 106 for dependency consistency verification in accordance with one or more embodiments.

Indeed, FIG. 6 illustrates a dependency graph 600 having a plurality of nodes 602a-602e representing API calls indicated by a task plan and a plurality of edges 604a-604e representing the interdependencies between the API calls. In particular, the plurality of edges 604a-604e include directed edges. As shown, a portion of the dependency graph 600 including the nodes 602c-602e and the edges 604c-604e includes cyclic dependencies. For instance, traversal of the dependency graph 600 results in repeated visits to the node 602e (e.g., via the edges 604a-604b and the edge 604c). Thus, in some embodiments, the text-to-file editing system 106 determines that the dependency graph 600 is not a directed acyclic graph and determines to revise the corresponding task plan. In some cases, the text-to-file editing system 106 includes this error in the error log generated via the one or more code verifications performed on the task plan.

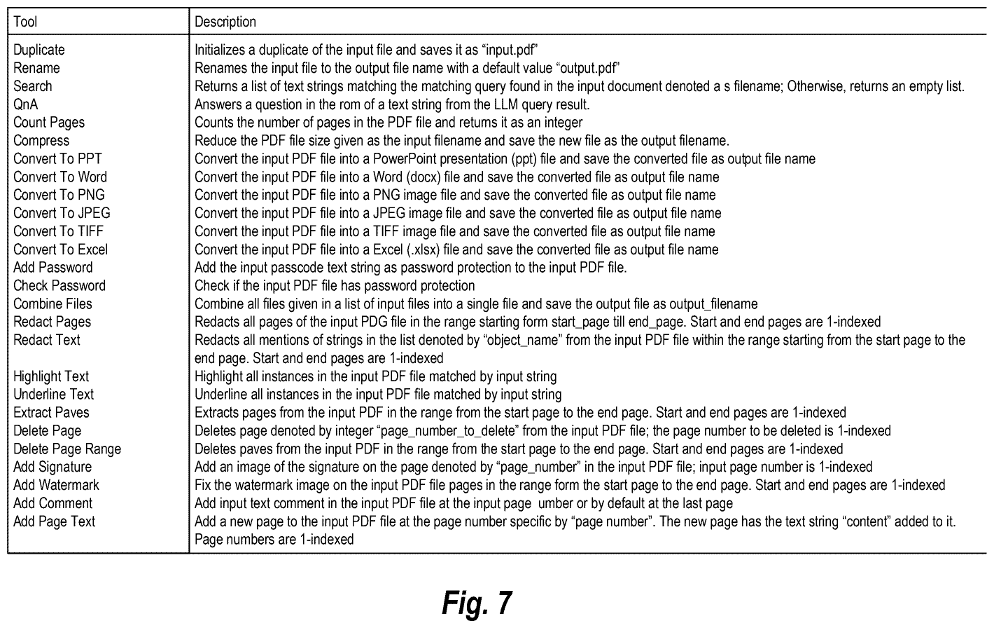

As previously mentioned, in some embodiments, the text-to-file editing system 106 uses tool documentation during task planning. FIG. 7 illustrates example tool documentation used by the text-to-file editing system 106 in accordance with one or more embodiments. It should be noted that, while the code documentation of FIG. 7 corresponds to a particular type of digital file a PDF file—other implementations of the text-to-file editing system 106 use code documentation for other types of digital files. The tool documentation shown includes a name of an available tool and a brief description of that tool. In particular, the brief description indicates the function/utility of the tool, indicating the input arguments and return values used in implementing the tool. In some cases, the tool documentation is further used in code generation (e.g., to generate the code generation prompt). Thus, in some instances, the limited information facilitates API encapsulation and prevents the language machine learning model from accessing sensitive information.

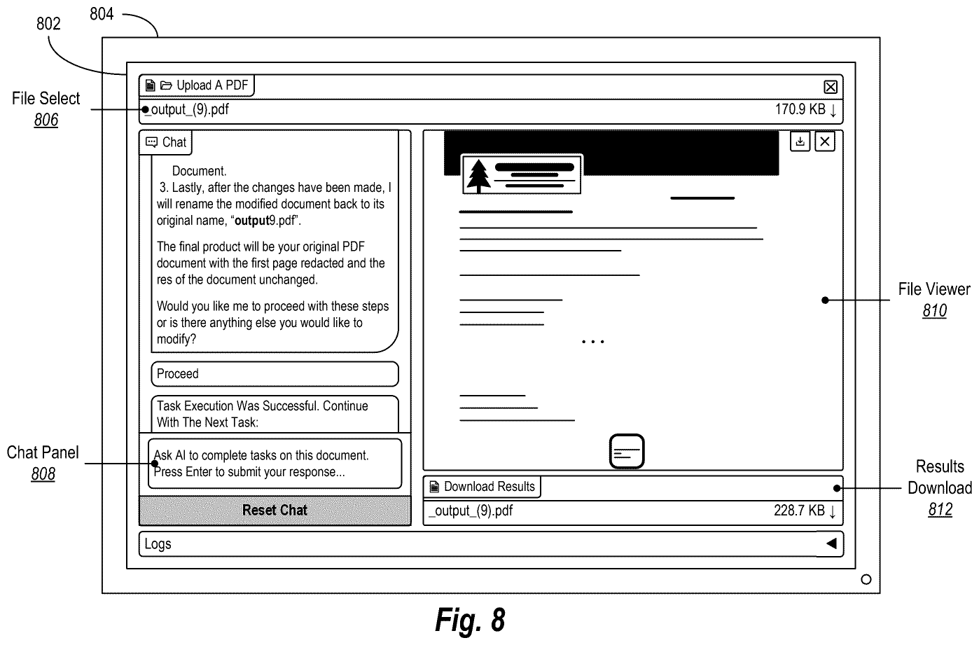

As indicated, in one or more embodiments, the text-to-file editing system 106 interacts with a client device to modify a digital file. In particular, in some cases, the text-to-file editing system 106 receives input and provides output through a graphical user interface of a client device. FIG. 8 illustrates a graphical user interface used by the text-to-file editing system 106 to modify a digital file in accordance with one or more embodiments.

Indeed, as shown in FIG. 8, the text-to-file editing system 106 provides a graphical user interface 802 for display on a client device 804. The text-to-file editing system 106 provides, within the graphical user interface 802, a file select element 806 to enable the upload of a digital file to be modified. In some cases, the file select element 806 enables a user to browse local storage and select a digital file to upload for modification. In some instances, the file select element 806 enables a user to provide the location (e.g., via link) or a name of the digital file. In some instances, the file select element 806 enables a drag-and-drop of the digital file.

As further shown, the text-to-file editing system 106 provides a chat panel 808 within the graphical user interface 802. In some cases, the text-to-file editing system 106 uses the chat panel 808 to receive a user request for modifying a digital file submitted via the file select element 806. For instance, in some embodiments, the text-to-file editing system 106 receives, via the chat panel 808, natural language text that describes one or more edits to be made to the digital file. In certain implementations, the text-to-file editing system 106 further uses the chat panel 808 to communicate with the user of the client device 804. For instance, in some cases, the text-to-file editing system 106 provides a natural language description of a determined task plan for display within the chat panel 808. The text-to-file editing system 106 further receives feedback on the task plan description via the chat panel 808. Thus, in some instances, the text-to-file editing system 106 uses the chat panel 808 to implement multi-turn user feedback by engaging in a back-and-forth with the user to revise the task plan as desired.

Additionally, as shown, the text-to-file editing system 106 provides a file viewer 810 for display within the graphical user interface 802. In some cases, the text-to-file editing system 106 provides the digital file to be modified for display within the file viewer 810. In some instances, the text-to-file editing system 106 provides the modified digital file for display within the file viewer 810. For instance, in some embodiments, the text-to-file editing system 106 replaces the digital file with the modified digital file within the file viewer 810 to display the changes that have been made.

Further, as shown, the text-to-file editing system 106 provides an option 812 for downloading the modified digital file. Indeed, in some embodiments, upon completing modification of the digital file in accordance with the user request, the text-to-file editing system 106 provides the modified result for download. Thus, one or more embodiments of the text-to-file editing system 106 use the graphical user interface 802 to provide an end-to-end user experience for modifying a digital file.

Turning now to FIG. 9, additional detail will now be provided regarding various components and capabilities of the text-to-file editing system 106. In particular, FIG. 9 illustrates the text-to-file editing system 106 implemented by the computing device 900 (e.g., the server device(s) 102 and/or one of the client devices 110a-110n discussed above with reference to FIG. 1). Additionally, the text-to-file editing system 106 is part of the file editing system 104. As shown in FIG. 9, the text-to-file editing system 106 includes, but is not limited to, a graphical user interface manager 902, a task plan generator 904, a plan verification engine 906, an executable code generator 908, a code compiler 910, a task execution engine 912, and data storage 914 (which includes language machine learning models 916).

As just mentioned, and as illustrated in FIG. 9, the text-to-file editing system 106 includes the graphical user interface manager 902. In one or more embodiments, the graphical user interface manager 902 manages a graphical user interface implemented for modifying digital files. For instance, in some cases, the graphical user interface manager 902 provides various options for receiving input (e.g., user requests, digital files to be modified, and/or multi-turn user feedback on determined task plans) and providing output (e.g., modified digital files).

Additionally, as shown in FIG. 9, the text-to-file editing system 106 includes the task plan generator 904. In one or more embodiments, the task plan generator 904 generates task plans to modify digital files in accordance with user requests. For instance, in some cases, the task plan generator 904 generates a task planning prompt based on a user request and uses a language machine learning model to generate a task plan from the task planning prompt. In some implementations, the task plan generator 904 uses tool documentation and retrieval-augmented tool selection in generating task planning prompts.

As further shown in FIG. 9, the text-to-file editing system 106 includes the plan verification engine 906. In one or more embodiments, the plan verification engine 906 revises a determined task plan for modifying a digital image. For instance, in some embodiments, the plan verification engine 906 performs one or more code verifications on the determined task plan, generates an error log identifying detected errors, and generates a self-correction prompt from the error log and the task plan. In certain cases, the plan verification engine 906 uses a language machine learning model to generate a corrected task plan that corrects one or more of the errors.

As shown in FIG. 9, the text-to-file editing system 106 also includes the executable code generator 908. In one or more embodiments, the executable code generator 908 generates executable code for implementing a determined task plan (e.g., a corrected task plan). For instance, in some cases, the executable code generator 908 generates a code generation prompt for generating executable code. In some instances, the executable code generator 908 uses API encapsulation, retrieval-augmented few shot prompting, and/or one or more guardrails in generating the code generation prompt. In some implementations, the executable code generator 908 uses a language machine learning model to generate executable code from the code generation prompt. In some implementations, the executable code generator 908 further uses a language machine learning model to generate corrected executable code (e.g., from a self-correction prompt generated from the executable code and an error log identifying errors within the executable code).

As shown in FIG. 9, the text-to-file editing system 106 further includes the code compiler 910. In some cases, the code compiler 910 facilitates simulation and revision of executable code. For instance, in some embodiments, the code compiler 910 simulates execution of executable code and generates an error log identifying one or more errors detected during simulated execution.

Additionally, as shown in FIG. 9, the text-to-file editing system 106 includes the task execution engine 912. In one or more embodiments, the task execution engine 912 executes executable code (e.g., corrected executable code) to generate a modified digital image.

Further, as shown in FIG. 9, the text-to-file editing system 106 includes data storage 914. In particular, data storage 914 includes language machine learning models 916. Indeed, in some cases, data storage 914 includes one or more language machine learning models for task plan generation, task plan revision, executable code generation, and/or executable code revision.

Each of the components 902-916 of the text-to-file editing system 106 optionally include software, hardware, or both. For example, in some cases, the components 902-916 include one or more instructions stored on a computer-readable storage medium and executable by processors of one or more computing devices, such as a client device or server device. When executed by the one or more processors, the computer-executable instructions of one or more embodiments of the text-to-file editing system 106 cause the computing device(s) to perform the methods described herein. Alternatively, in some instances, the components 902-916 include hardware, such as a special-purpose processing device to perform a certain function or group of functions. Alternatively, in certain implementations, the components 902-916 of the text-to-file editing system 106 include a combination of computer-executable instructions and hardware.

Furthermore, in one or more embodiments, the components 902-916 of the text-to-file editing system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 902-916 of the text-to-file editing system 106 are implemented as a stand-alone application, such as a desktop or mobile application. Furthermore, in some cases, the components 902-916 of the text-to-file editing system 106 are implemented as one or more web-based applications hosted on a remote server. Alternatively, or additionally, the components 902-916 of the text-to-file editing system 106 are implemented in a suite of mobile device applications or “apps.” For example, in one or more embodiments, the text-to-file editing system 106 comprises or operates in connection with digital software applications such as ADOBE@ACROBAT@, ADOBE@READER@, or ADOBE@DOCUMENT CLOUD®. The foregoing are either registered trademarks or trademarks of Adobe Inc. in the United States and/or other countries.

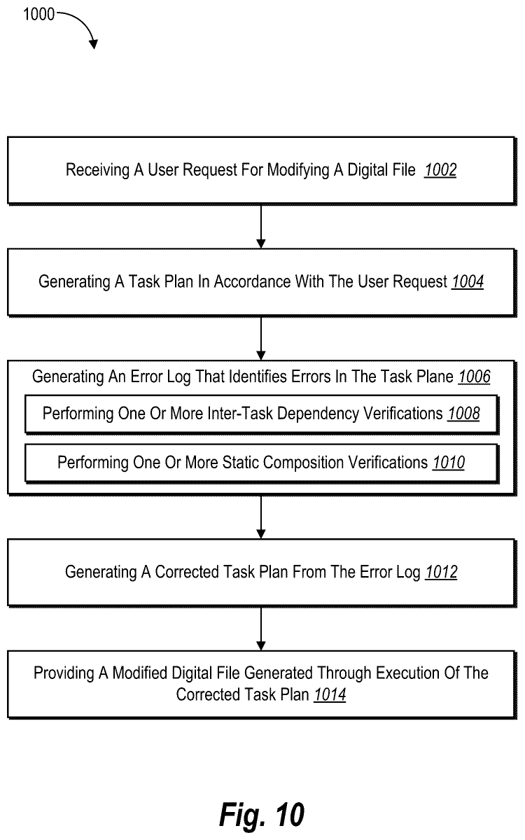

FIGS. 1-9, the corresponding text, and the examples provide a number of different methods, systems, devices, and non-transitory computer-readable media of the text-to-file editing system 106. In addition to the foregoing, one or more embodiments are also described in terms of flowcharts comprising acts for accomplishing the particular result, as shown in FIG. 10. In one or more embodiments, FIG. 10 is performed with more or fewer acts. Further, in some embodiments, the acts are performed in different orders. Additionally, in some cases, the acts described herein are repeated or performed in parallel with one another or in parallel with different instances of the same or similar acts.

FIG. 10 illustrates a flowchart of a series of acts for modifying a digital file based on a user request in accordance with one or more embodiments. FIG. 10 illustrates acts according to one embodiment, but alternative embodiments omit, add to, reorder, and/or modify any of the acts shown in FIG. 10. In some implementations, the acts of FIG. 10 are performed as part of a computer-implemented method. Alternatively, in some embodiments, a non-transitory computer-readable medium stores executable instructions thereon that, when executed by a processing device, cause the processing device to perform operations comprising the acts of FIG. 10. In some embodiments, a system performs the acts of FIG. 10. For example, in some cases, a system includes one or more memory devices. The system further includes one or more processors configured to cause the system to perform the acts of FIG. 10.

The series of acts 1000 includes an act 1002 for receiving a user request for modifying a digital file. For example, in one or more embodiments, the act 1002 involves receiving, from a client device, a user request for modifying a digital file.

The series of acts 1000 also includes an act 1004 for generating a task plan in accordance with the user request. For instance, in some embodiments, the act 1004 involves generating, using a language machine learning model, a task plan having formatted code that indicates one or more application programming interface calls to execute to modify the digital file in accordance with the user request.

Additionally, the series of acts 1000 includes an act 1006 for generating an error log that identifies one or more errors in the task plan. To illustrate, in some cases, the act 1006 involves generating, via one or more code verifications on the formatted code, an error log that identifies one or more errors in the task plan.

Indeed, as shown in FIG. 10, the act 1006 includes a sub-act 1008 for performing one or more inter-task dependency verifications. For example, in some cases, generating the error log via the one or more code verifications on the formatted code comprises generating the error log via one or more inter-task dependency verifications that check for at least one of dependency hallucination or dependency consistency within the formatted code. In some instances, generating the error log via the one or more inter-task dependency verifications that check for dependency consistency within the formatted code comprises: generating a dependency graph from the task plan, the dependency graph having a set of nodes corresponding to the one or more application programming interface calls indicated by the formatted code and a set of edges corresponding to interdependencies for the one or more application programming interface calls; and determining whether the dependency graph includes a directed acyclic graph.

Additionally, as shown in FIG. 10, the act 1006 includes a sub-act 1010 for performing one or more static composition verifications. For instance, in certain implementations, generating the error log via the one or more code verifications on the formatted code comprises generating the error log via one or more static composition verifications that check for at least one of syntax hallucination, tool hallucination, or argument validity within the formatted code.

Further, the series of acts 1000 includes an act 1012 for generating a corrected task plan from the error log. To illustrate, in certain cases, the act 1012 involves generating, from the error log and using the language machine learning model, a corrected task plan that corrects the one or more errors.

In one or more embodiments, the text-to-file editing system 106 further provides, for display on the client device, the corrected task plan; and generates, using the language machine learning model, a modified task plan based on user feedback on the corrected task plan received via the client device. As such, in some cases, providing, for display on the client device, the modified digital file generated through execution of the corrected task plan comprises providing, for display on the client device, the modified digital file generated through execution of the modified task plan.

The series of acts 1000 also includes an act 1014 for providing a modified digital file generated through execution of the corrected task plan. For example, in some embodiments, the act 1014 involves providing, for display on the client device, a modified digital file generated through execution of the corrected task plan.

In one or more embodiments, the text-to-file editing system 106 further generates, using at least one language machine learning model, executable code for modifying the digital file from the corrected task plan. As such, in some cases, providing the modified digital file generated through execution of the corrected task plan comprises providing the modified digital file generated through execution of the executable code. In some instances, generating the executable code using the at least one language machine learning model comprises: generating an encapsulated code generation prompt that includes encapsulated information for at least one application programming interface call of the corrected task plan; and generating, using the at least one language machine learning model, the executable code from the encapsulated code generation prompt. Additionally, in certain embodiments, generating the encapsulated code generation prompt that includes the encapsulated information comprises generating the encapsulated code generation prompt that includes the encapsulated information and one or more guardrails that correspond to at least one of code generation syntax, software import compatibility, or data privacy related to file handling. In some cases, the text-to-file editing system 106 further generates, using the at least one language machine learning model, corrected executable code that corrects at least one error identified in the executable code; and providing the modified digital file generated through execution of the executable code comprises providing the modified digital file generated through execution of the corrected executable code.

To provide an illustration, in one or more embodiments, the text-to-file editing system 106 determines, using a language machine learning model, a task plan having formatted code that indicates one or more application programming interface calls to execute to modify a digital file in accordance with a user request; determines, using the language machine learning model, a corrected task plan that corrects one or more errors identified in the task plan; generates, using at least one language machine learning model, executable code for modifying the digital file from the corrected task plan; generates, using the at least one language machine learning model, corrected executable code that corrects at least one error identified in the executable code; and modifies the digital file in accordance with the user request by executing the corrected executable code.

In some embodiments, the text-to-file editing system 106 generates a task planning prompt having information for a set of tools of an editing application that are available for modifying the digital file; and determines, using the language machine learning model, the task plan having the formatted code that indicates the one or more application programming interface calls to execute by generating, using the language machine learning model and from the task planning prompt, the formatted code that indicates at least one application programming interface call associated with at least one tool from the set of tools of the editing application.

In some cases, the text-to-file editing system 106 generates a task planning prompt having at least one sample pair comprising a sample user request and a sample task plan that corresponds to the sample user request; and determines, using the language machine learning model, the task plan by generating, using the language machine learning model, the task plan from the task planning prompt. In some instances, the text-to-file editing system 106 determines the at least one sample pair for the task planning prompt by generating a request embedding from the user request; generating a plurality of sample request embeddings from a plurality of sample user requests corresponding to a plurality of sample pairs; and determining the at least one sample pair based on comparing the request embedding to the plurality of sample request embeddings. In some implementations, the text-to-file editing system 106 generates a code generation prompt having at least one additional sample pair comprising the sample task plan and sample executable code that corresponds to the sample task plan; and generates, using the at least one language machine learning model, the executable code for modifying the digital file from the corrected task plan by generating, using the at least one language machine learning model, the executable code for modifying the digital file from the corrected task plan and the code generation prompt.

In some cases, the text-to-file editing system 106 determines the one or more errors in the task plan by performing a plurality of code verifications on the formatted code, the plurality of code verifications including a set of inter-task dependency verifications and a set of static composition verifications. Further, in some instances, the text-to-file editing system 106 modifies the digital file in accordance with the user request by extracting one or more pages from the digital file, deleting one or more pages from the digital file, redacting one or more pages from the digital file, or redacting text from the digital file.

To provide another illustration, in one or more embodiments, the text-to-file editing system 106 receives a digital file and a user request for modifying the digital file; generates, using a language machine learning model, a task plan having formatted code that indicates one or more application programming interface calls to execute to modify the digital file in accordance with the user request; generates an encapsulated code generation prompt that includes encapsulated information for the one or more application programming interface calls of the task plan; generates, using at least one language machine learning model and from the encapsulated code generation prompt, executable code for modifying the digital file; and modifies the digital file in accordance with the user request by executing the executable code.

In some embodiments, modifying the digital file in accordance with the user request includes converting the digital file from a first format to a second format. In some cases, generating the encapsulated code generation prompt that includes the encapsulated information for the one or more application programming interface calls comprises generating the encapsulated code generation prompt having information limited to a function name, one or more input arguments, and one or more returned values corresponding to the one or more application programming interface calls. Further, in some instances, the text-to-file editing system 106 further generates a corrected task plan by iteratively updating the task plan to correct one or more errors identified in the task plan. As such, in some cases, generating the encapsulated code generation prompt that includes the encapsulated information for the one or more application programming interface calls of the task plan comprises generating the encapsulated code generation prompt that includes the encapsulated information for at least one application programming interface call of the corrected task plan.

Some embodiments of the present disclosure comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, in some cases, one or more of the processes described herein are implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

In one or more embodiments, computer-readable media include various available media that is accessible by a general purpose or special purpose computer system. Computer-readable media that store computer-executable instructions are non-transitory computer-readable storage media (devices). Computer-readable media that carry computer-executable instructions are transmission media. Thus, by way of example, and not limitation, one or more embodiments of the disclosure comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which is usable to store desired program code means in the form of computer-executable instructions or data structures and which is accessible by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. In some cases, transmissions media includes a network and/or data links which are usable to carry desired program code means in the form of computer-executable instructions or data structures and which is accessible by a general purpose or special purpose computer. Combinations of the above should also be included within the scope of computer-readable media.

Further, upon reaching various computer system components, program code means in the form of computer-executable instructions or data structures is transferrable automatically from transmission media to non-transitory computer-readable storage media (devices) (or vice versa). For example, in some cases, computer-executable instructions or data structures received over a network or data link are buffered in RAM within a network interface module (e.g., a “NIC”), and then eventually transferred to computer system RAM and/or to less volatile computer storage media (devices) at a computer system. Thus, it should be understood that, in some cases, non-transitory computer-readable storage media (devices) are included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. In some instances, the computer executable instructions are, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that one or more embodiments are practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. Some implementations are practiced in distributed system environments where local and remote computer systems, which are linked (either by hardwired data links, wireless data links, or by a combination of hardwired and wireless data links) through a network, both perform tasks. In some implementations, in a distributed system environment, program modules are located in both local and remote memory storage devices.

Some embodiments of the present disclosure are implemented in cloud computing environments. In this description, “cloud computing” is defined as a model for enabling on-demand network access to a shared pool of configurable computing resources. For example, in some cases, cloud computing is employed in the marketplace to offer ubiquitous and convenient on-demand access to the shared pool of configurable computing resources. In some instances, the shared pool of configurable computing resources is rapidly provisioned via virtualization and released with low management effort or service provider interaction, and then scaled accordingly.

In one or more embodiments, a cloud-computing model is composed of various characteristics such as, for example, on-demand self-service, broad network access, resource pooling, rapid elasticity, measured service, and so forth. In some embodiments, a cloud-computing model exposes various service models, such as, for example, Software as a Service (“SaaS”), Platform as a Service (“PaaS”), and Infrastructure as a Service (“IaaS”). In some instances, a cloud-computing model is deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that is configured to perform one or more of the processes described above in some embodiments. One will appreciate that one or more computing devices, such as the computing device 1100, represent the computing devices described above (e.g., the server device(s) 102 and/or the client devices 110a-110n) in some implementations. In one or more embodiments, the computing device 1100 is a mobile device (e.g., a mobile telephone, a smartphone, a PDA, a tablet, a laptop, a camera, a tracker, a watch, a wearable device). In some embodiments, the computing device 1100 is a non-mobile device (e.g., a desktop computer or another type of client device). Further, in certain embodiments, the computing device 1100 is a server device that includes cloud-based processing and storage capabilities.

As shown in FIG. 11, the computing device 1100 includes one or more processor(s) 1102, memory 1104, a storage device 1106, input/output interfaces 1108 (or “I/O interfaces 1108”), and a communication interface 1110, which are communicatively coupled by way of a communication infrastructure (e.g., bus 1112). While the computing device 1100 is shown in FIG. 11, the components illustrated in FIG. 11 are not intended to be limiting. Additional or alternative components are used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 retrieve (or fetch) the instructions from an internal register, an internal cache, memory 1104, or a storage device 1106 and decode and execute them in some implementations.

The computing device 1100 includes memory 1104, which is coupled to the processor(s) 1102. In certain cases, the memory 1104 is used for storing data, metadata, and programs for execution by the processor(s). In some instances, the memory 1104 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some embodiments, the memory 1104 includes internal or distributed memory.

The computing device 1100 includes a storage device 1106 including storage for storing data or instructions. As an example, and not by way of limitation, in some cases, the storage device 1106 includes a non-transitory storage medium described above. In some embodiments, the storage device 1106 includes a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. In one or more embodiments, these I/O interfaces 1108 include a mouse, keypad or a keyboard, a touch screen, camera, optical scanner, network interface, modem, other known I/O devices or a combination of such I/O interfaces 1108. In some cases, the touch screen is activated with a stylus or a finger.

In one or more embodiments, the I/O interfaces 1108 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. In some cases, the graphical data is representative of one or more graphical user interfaces and/or any other graphical content that serves a particular implementation.

The computing device 1100 further includes a communication interface 1110. In some cases, the communication interface 1110 includes hardware, software, or both. The communication interface 1110 provides one or more interfaces for communication (such as, for example, packet-based communication) between the computing device and one or more other computing devices or one or more networks. As an example, and not by way of limitation, in some cases, communication interface 1110 includes a network interface controller (NIC) or network adapter for communicating with an Ethernet or other wire-based network or a wireless NIC (WNIC) or wireless adapter for communicating with a wireless network, such as a WI-FI. The computing device 1100 further includes a bus 1112. In some cases, the bus 1112 includes hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

Various implementations of the present invention are embodied in other specific forms without departing from its spirit or essential characteristics. The described embodiments are to be considered in all respects only as illustrative and not restrictive. For example, in some embodiments, the methods described herein are performed with less or more steps/acts or the steps/acts are performed in differing orders. Additionally, in some cases, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a client device, a user request for modifying a digital file;
generating, using a language machine learning model, a task plan having formatted code that indicates one or more application programming interface calls to execute to modify the digital file in accordance with the user request;
generating, via one or more code verifications on the formatted code, an error log that identifies one or more errors in the task plan;
generating, from the error log and using the language machine learning model, a corrected task plan that corrects the one or more errors; and
providing, for display on the client device, a modified digital file generated through execution of the corrected task plan.

2. The computer-implemented method of claim 1, wherein generating the error log via the one or more code verifications on the formatted code comprises generating the error log via one or more inter-task dependency verifications that check for at least one of dependency hallucination or dependency consistency within the formatted code.

3. The computer-implemented method of claim 2, wherein generating the error log via the one or more inter-task dependency verifications that check for dependency consistency within the formatted code comprises:
generating a dependency graph from the task plan, the dependency graph having a set of nodes corresponding to the one or more application programming interface calls indicated by the formatted code and a set of edges corresponding to interdependencies for the one or more application programming interface calls; and
determining whether the dependency graph includes a directed acyclic graph.

4. The computer-implemented method of claim 1, wherein generating the error log via the one or more code verifications on the formatted code comprises generating the error log via one or more static composition verifications that check for at least one of syntax hallucination, tool hallucination, or argument validity within the formatted code.

5. The computer-implemented method of claim 1, further comprising:
providing, for display on the client device, the corrected task plan; and
generating, using the language machine learning model, a modified task plan based on user feedback on the corrected task plan received via the client device,
wherein providing, for display on the client device, the modified digital file generated through execution of the corrected task plan comprises providing, for display on the client device, the modified digital file generated through execution of the modified task plan.

6. The computer-implemented method of claim 1,
further comprising generating, using at least one language machine learning model, executable code for modifying the digital file from the corrected task plan,
wherein providing the modified digital file generated through execution of the corrected task plan comprises providing the modified digital file generated through execution of the executable code.

7. The computer-implemented method of claim 6, wherein generating the executable code using the at least one language machine learning model comprises:
generating an encapsulated code generation prompt that includes encapsulated information for at least one application programming interface call of the corrected task plan; and
generating, using the at least one language machine learning model, the executable code from the encapsulated code generation prompt.

8. The computer-implemented method of claim 7, wherein generating the encapsulated code generation prompt that includes the encapsulated information comprises generating the encapsulated code generation prompt that includes the encapsulated information and one or more guardrails that correspond to at least one of code generation syntax, software import compatibility, or data privacy related to file handling.

9. The computer-implemented method of claim 6,
further comprising generating, using the at least one language machine learning model, corrected executable code that corrects at least one error identified in the executable code,
wherein providing the modified digital file generated through execution of the executable code comprises providing the modified digital file generated through execution of the corrected executable code.

10. A system comprising:
one or more memory devices; and
one or more processors configured to cause the system to:
determine, using a language machine learning model, a task plan having formatted code that indicates one or more application programming interface calls to execute to modify a digital file in accordance with a user request;
determine, using the language machine learning model, a corrected task plan that corrects one or more errors identified in the task plan;
generate, using at least one language machine learning model, executable code for modifying the digital file from the corrected task plan;
generate, using the at least one language machine learning model, corrected executable code that corrects at least one error identified in the executable code; and
modify the digital file in accordance with the user request by executing the corrected executable code.

11. The system of claim 10, wherein the one or more processors are further configured to cause the system to:
generate a task planning prompt having information for a set of tools of an editing application that are available for modifying the digital file; and
determine, using the language machine learning model, the task plan having the formatted code that indicates the one or more application programming interface calls to execute by generating, using the language machine learning model and from the task planning prompt, the formatted code that indicates at least one application programming interface call associated with at least one tool from the set of tools of the editing application.

12. The system of claim 10, wherein the one or more processors are further configured to cause the system to:
generate a task planning prompt having at least one sample pair comprising a sample user request and a sample task plan that corresponds to the sample user request; and
determine, using the language machine learning model, the task plan by generating, using the language machine learning model, the task plan from the task planning prompt.

13. The system of claim 12, wherein the one or more processors are further configured to cause the system to determine the at least one sample pair for the task planning prompt by:
generating a request embedding from the user request;
generating a plurality of sample request embeddings from a plurality of sample user requests corresponding to a plurality of sample pairs; and
determining the at least one sample pair based on comparing the request embedding to the plurality of sample request embeddings.

14. The system of claim 12, wherein the one or more processors are further configured to cause the system to:
generate a code generation prompt having at least one additional sample pair comprising the sample task plan and sample executable code that corresponds to the sample task plan; and
generate, using the at least one language machine learning model, the executable code for modifying the digital file from the corrected task plan by generating, using the at least one language machine learning model, the executable code for modifying the digital file from the corrected task plan and the code generation prompt.

15. The system of claim 10, wherein the one or more processors are configured to cause the system to determine the one or more errors in the task plan by performing a plurality of code verifications on the formatted code, the plurality of code verifications including a set of inter-task dependency verifications and a set of static composition verifications.

16. The system of claim 10, wherein the one or more processors are configured to cause the system to modify the digital file in accordance with the user request by extracting one or more pages from the digital file, deleting one or more pages from the digital file, redacting one or more pages from the digital file, or redacting text from the digital file.

17. A non-transitory computer-readable medium storing executable instructions which, when executed by a processing device, cause the processing device to perform operations comprising:
receiving a digital file and a user request for modifying the digital file;
generating, using a language machine learning model, a task plan having formatted code that indicates one or more application programming interface calls to execute to modify the digital file in accordance with the user request;
generating an encapsulated code generation prompt that includes encapsulated information for the one or more application programming interface calls of the task plan;
generating, using at least one language machine learning model and from the encapsulated code generation prompt, executable code for modifying the digital file; and
modifying the digital file in accordance with the user request by executing the executable code.

18. The non-transitory computer-readable medium of claim 17, wherein modifying the digital file in accordance with the user request includes converting the digital file from a first format to a second format.

19. The non-transitory computer-readable medium of claim 17, wherein generating the encapsulated code generation prompt that includes the encapsulated information for the one or more application programming interface calls comprises generating the encapsulated code generation prompt having information limited to a function name, one or more input arguments, and one or more returned values corresponding to the one or more application programming interface calls.

20. The non-transitory computer-readable medium of claim 17, wherein:
the operations further comprise generating a corrected task plan by iteratively updating the task plan to correct one or more errors identified in the task plan; and
generating the encapsulated code generation prompt that includes the encapsulated information for the one or more application programming interface calls of the task plan comprises generating the encapsulated code generation prompt that includes the encapsulated information for at least one application programming interface call of the corrected task plan.
